(19) United States
(12) Patent Application Publication
(10) Pub. No.: US 2014/0261571 A1
(43) Pub. Date: Sep. 18, 2014

(54) SUBSTRATE CLEANING AND DRYING METHOD AND SUBSTRATE DEVELOPING METHOD

(71) Applicant: SOKUDO CO., LTD., Kyoto (JP)

(72) Inventors: Tomohiro GOTO, Kyoto-shi (JP); Masahito KASHIYAMA, Kyoto-shi (JP); Yasuo TAKAHASHI, Kyoto-shi (JP); Akihiko MORITA, Kyoto-shi (JP)

(73) Assignee: SOKUDO CO., LTD., Kyoto (JP)

(21) Appl. No.: 14/156,848

(22) Filed: Jan. 16, 2014

(30) Foreign Application Priority Data
Mar. 15, 2013 (JP) 2013-053342

(51) Int. Cl. B08B 3/08

(52) U.S. Cl. CPC B08B 3/08
USPC 134/33

(57) ABSTRACT

Provided is a substrate cleaning and drying method, including a cleaning step of cleaning a developed substrate by supplying a cleaning liquid to the substrate; a puddle-forming step of forming a puddle of the cleaning liquid on the substrate; a film-thinning step of thinning a film thickness of the cleaning liquid on the substrate; and a drying step of drying the substrate by spinning the substrate and generating outward airflow and inward airflow between the outward airflow and the substrate, the outward airflow covering a portion above the substrate and the inward airflow causing removal of the cleaning liquid on the substrate.

### CROSS REFERENCE TO RELATED APPLICATIONS

This application claims priority to Japanese Patent Application No. 2013-053342 filed on Mar. 15, 2013, the entire contents of which are incorporated by reference herein.

### TECHNICAL FIELD

The present invention relates to a substrate cleaning and drying method of cleaning and drying a semiconductor wafer, a glass substrate for a photomask, a glass substrate for a liquid crystal display apparatus, or a substrate for an optical disk (hereinafter, called simply a “substrate”), and relates to a substrate developing method including the substrate cleaning and drying method.

### BACKGROUND ART

In the photolithography, a resist film formed on a substrate is exposed in given patterns, and the exposed resist film is developed. In development, developer is supplied to the substrate to dissolve a dissoluble portion of the resist film. Subsequently, a cleaning liquid is supplied to the substrate to clean off the developer or a dissolved product generated through dissolving the resist film. When the dissoluble portion is removed from the substrate, resist patterns appear on the substrate. Moreover, the cleaning liquid is removed from the substrate, whereby the substrate is dried.

One exemplary method of cleaning and drying the substrate is disclosed, for example, in Japanese Patent Publication No. 2012-165000A. In the method, a cleaning liquid nozzle configured to eject a cleaning liquid and a gas nozzle configured to eject gas are disposed close to one another above the substrate. Both the nozzles are moved while ejecting the cleaning liquid and gas respectively and simultaneously.

However, the example of the conventional apparatus with such a construction has the following problems.

Specifically, in the prior art, when the gas nozzle is located at a position, a dried portion of the substrate to be dried is limited to only a local portion of the substrate immediately below the gas nozzle and therearound. The gas nozzle is moved above the substrate, thereby drying the substrate entirely. Consequently, it costs a relatively longer time to dry the entire substrate.

In addition, since the cleaning liquid nozzle and the gas nozzle are disposed close to one another, gas flow causes flow turbulence of the cleaning liquid. This may generate mist or droplets. As a result, it becomes difficult to increase a discharge amount of gas and to shorten a drying time.

### SUMMARY OF INVENTION

The present invention has been made regarding the state of the art noted above, and its one object is to provide a substrate cleaning and drying method as well as a substrate developing method that allow drying of a substrate in a short time.

This invention is constituted as stated below to achieve the above object.

The present invention discloses a substrate cleaning and drying method. The method includes:

a cleaning step of cleaning a developed substrate by supplying a cleaning liquid to the substrate;

a puddle-forming step of forming a puddle of the cleaning liquid on the substrate;

a film-thinning step of thinning a film thickness of the cleaning liquid on the substrate; and

a drying step of drying the substrate by spinning the substrate and generating outward airflow and inward airflow between the outward airflow and the substrate, the outward airflow covering a portion above the substrate and the inward airflow causing removal of the cleaning liquid on the substrate.

The substrate cleaning and drying method of the present invention includes the cleaning step, the puddle-forming step, the film-thinning step, and the drying step. In the cleaning step, developer or a dissolved product on the substrate is cleaned off. As a result, resist patterns appear on a top face of the substrate.

In the puddle-forming step, even when the top face of the substrate has repellency, a film of the cleaning liquid can be formed on the entire top face of the substrate. The resist patterns are entirely immersed in a liquid film (the cleaning liquid).

In the film-thinning step, the liquid film is thinned while being formed on the substrate. This achieves a reduced amount of the cleaning liquid on the substrate with the resist patterns entirely immersed in the liquid film (the cleaning liquid).

In the drying step, the substrate is spun and the outward airflow and the inward airflow is generated. A force of the inward airflow and a centrifugal force due to spinning the substrate allow the cleaning liquid to be moved on the substrate. The outward airflow is formed above the inward airflow. The outward airflow causes the force of the inward airflow to act on the cleaning liquid effectively. Consequently, the cleaning liquid can be removed rapidly from the substrate. That is, the substrate can be dried rapidly. In addition, since the film-thinning step is performed in advance prior to the drying step, a few amount of the cleaning liquid is moved during the drying step. This achieves drying the substrate in a further shorter time.

The cleaning liquid may cause collapse of the resist patterns. Here, a force occurring due to the cleaning liquid and collapsing the resist patterns is called a “collapse force” where appropriate. The collapse force never occurs when the resist patterns are entirely immersed in the cleaning liquid, but occurs when the resist patterns are partially immersed in the cleaning liquid (i.e., when the resist patterns are partially dried). In the embodiment of the present invention, when the puddle-forming step and the film-thinning step are performed, the resist patterns are entirely immersed in the cleaning liquid. Accordingly, no collapse force occurs. The collapse force may occur only when the drying step is performed. As noted above, the drying step is completed in a short time. Consequently, in the embodiment of the present invention, no collapse force occurs until the drying step starts, and the drying step is completed in a short time after the drying step starts. This allows a shorten period during which the collapse force occurs, suitably suppressing collapse of the resist patterns.

In the above embodiment of the present invention, the inward airflow preferably runs to a top face of the substrate. The outward airflow preferably runs in the portion above the substrate in a substantially horizontal direction. The outward airflow can suitably cover a portion above the substrate held substantially horizontal. The inward airflow impinges (impacts) on the top face of the substrate. Consequently, the inward airflow allows the cleaning liquid on the substrate to be moved actively.

Moreover, in the above embodiment of the present invention, the inward airflow preferably impinges on the top face of the substrate to spread circumferentially. The outward airflow preferably causes a reduced level of the inward airflow spreading circumferentially. The inward airflow is divided into airflow before impinging on the substrate and airflow after impinging on the substrate in accordance with its direction. The airflow after impinging on the substrate spreads circumferentially. The outward airflow guides the inward airflow mostly spreading circumferentially. Consequently, the inward airflow spreading circumferentially flows adjacent to the top face of the substrate to move the cleaning liquid suitably. As a result, the cleaning liquid can be removed from the substrate effectively.

Moreover, in the embodiment above of the present invention, the outward airflow preferably runs from the center toward a periphery edge of the substrate in plan view. The inward airflow preferably impinges on the center of the substrate to spread to the periphery edge of the substrate. The center of the top face of the substrate is primarily dried. That is, the center of the substrate is dried prior to the other portions of the substrate. The substrate is dried from the center toward the periphery edge thereof. Eventually, the substrate is entirely dried. Here, the outward airflow is directed substantially parallel to the inward airflow spreading to the periphery edge. Consequently, the outward airflow can smoothly guide the inward airflow spreading to the periphery edge. The inward airflow spreading to the periphery edge causes suitable movement of the cleaning liquid.

Moreover, in the embodiment of the present invention, it is preferable that the outward airflow is generated by ejecting gas from a portion above the center of the substrate in a substantially horizontal direction, and that the inward airflow is generated by ejecting gas downwardly from the portion above the center of the substrate in a substantially vertical direction. Ejecting gas from a suitable position in a suitable direction allows generation of the outward air flow and the inward airflow. Consequently, suitable generation of the outward airflow and inward airflow can be obtained with no individual guide member or straightening member configured to flow gas in a specific direction.

Moreover, in the embodiment of the present invention, the outward airflow and the inward airflow is preferably generated simultaneously through a single gas nozzle. This allows a reduced number of parts. Particularly, when an ejecting position of gas for generating the outward airflow is the same as that for generating the inward airflow, a reduced size of the gas nozzle can be obtained suitably.

Moreover, in the embodiment of the present invention, the outward airflow is preferably generated by ejecting gas circumferentially from a side face of the gas nozzle, and the inward airflow is preferably generated by ejecting gas downwardly from a lower surface of the gas nozzle. Ejecting gas from the side face of the gas nozzle allows generation of the outward airflow covering a portion above the substrate suitably. Moreover, ejecting gas from the lower surface of the gas nozzle allows suitably generation of the inward airflow between the substrate and the outward airflow.

Moreover, in the embodiment of the present invention, the gas nozzle is preferably smaller than the substrate in plan view. This avoids an enlarged apparatus.

Moreover, in the embodiment of the present invention, it is preferable in the drying step that the gas nozzle is moved from the portion above the center of the substrate in a substantially horizontal direction while generating the outward airflow and the inward airflow. When located above the center of the substrate, the gas nozzle ejects the inward airflow toward the center of the substrate. Thereafter, when moved in a substantially horizontal direction, the gas nozzle ejects the inward airflow toward an area out of the center of the substrate. This achieves more effective movement of the cleaning liquid on the substrate.

Moreover, in the embodiment of the present invention, it is preferable that no cleaning liquid is supplied to the substrate in the drying step. This facilitates increased flow rates of the outward airflow and the inward airflow. Accordingly, the substrate can be dried in a shorter time.

Moreover, in the embodiment of the present invention, it is preferable that a periphery edge of the substrate is not dried prior to an inside of the periphery edge in the drying step with a spinning rate of the substrate being a given upper limit or less. Controlling the spinning rate of the substrate at the upper limit or less allows suppression of drying the periphery edge of the substrate prior to the inside of the periphery edge. This causes smooth movement of the cleaning liquid to the periphery edge of the substrate. Consequently, reduced quality of substrate processing including the cleaning step and drying step can be suppressed.

Another aspect of the present invention discloses a substrate developing method. The method includes:

a developing step of developing a substrate by supplying developer to the substrate;

a cleaning step of cleaning the substrate by supplying a cleaning liquid to the developed substrate;

a puddle-forming step of forming a puddle of the cleaning liquid on the substrate;

a film-thinning step of thinning a film thickness of the cleaning liquid on the substrate; and

a drying step of drying the substrate by spinning the substrate and generating outward airflow and inward airflow between the outward airflow and the substrate, the outward airflow covering a portion above the substrate and the inward airflow causing movement of the cleaning liquid on the substrate.

According to the substrate developing method of the embodiment of the present invention, the substrate can be dried in a short time. Accordingly, collapse of resist patterns can suitably be suppressed. That is, reduced quality in a series of substrate processing including the developing step, the cleaning step and the drying step can be suppressed.

This specification also discloses embodiments concerning a substrate cleaning and drying method and a substrate developing method as under.

(1) In the embodiment above of the present invention, it is preferable that the outward airflow guides the inward airflow such that the inward airflow spreading circumferentially runs along the top face of the substrate.

According to the embodiment (1) described above, the inward airflow spreading circumferentially allows the cleaning liquid to be moved suitably.

(2) In the embodiment above of the present invention, it is preferable that the outward airflow guides the inward airflow such that the inward airflow spreading circumferentially runs while coming into contact with the top face of the substrate.

According to the embodiment (2) described above, the inward airflow spreading circumferentially allows the cleaning liquid to be moved suitably.

(3) In the embodiment above of the present invention, it is preferable that the substrate having resist patterns appearing on the top face thereof is processed in the puddle-forming step, the film-thinning step, and the drying step, and that the resist patterns are entirely immersed into the cleaning liquid on the substrate during the puddle-forming step and the film-thinning step.

According to the embodiment (3) of the present invention, no collapse force occurs during the puddle-forming step and the film-thinning step, achieving suitable protection of the resist pattern.

(4) In the embodiment above of the present invention, it is preferable that the drying step starts after the cleaning step, the puddle-forming step, and the film-thinning are all completed.

According to the embodiment (4) of the present invention, the drying step is not performed simultaneously with any of the cleaning step, the puddle-forming step, and the film-thinning step. This obtains a further shortened drying time for the drying step.

### BRIEF DESCRIPTION OF DRAWINGS

For the purpose of illustrating the invention, there are shown in the drawings several forms which are presently preferred, it being understood, however, that the invention is not limited to the precise arrangement and instrumentalities shown.

FIG. 1 is a block diagram schematically illustrating a developing apparatus according to Embodiment 1.

FIG. 2A is a side view of a gas nozzle and a cleaning liquid nozzle, and

FIG. 2B is a plan view of the gas nozzle.

FIG. 3 illustrates an internal structure of the gas nozzle.

FIG. 4 is a flow chart of a procedure of a substrate developing method.

FIG. 5 is a timing chart illustrating the procedure of the substrate developing method.

FIGS. 6A to 6H are schematic views each illustrating a process to a substrate.

FIG. 7 is an explanatory view of primary drying.

FIG. 8 is a block diagram schematically illustrating a developing apparatus according to Embodiment 2.

FIG. 9 is a timing chart illustrating a procedure of a substrate developing method.

FIGS. 10A to 10D are schematic views each illustrating a process in a drying step.

### DESCRIPTION OF EMBODIMENTS

Description will be given hereinafter in detail of preferable embodiments with reference to drawings.

### Embodiment 1

Embodiment 1 of the present invention is to be described with reference to drawings.

1. Construction of Developing Apparatus

FIG. 1 is a block diagram schematically illustrating a developing apparatus according to Embodiment 1. A developing apparatus 1 performs treatment to a substrate (e.g., a semiconductor wafer) W having an exposed resist film formed on a surface thereof. Specifically, the developing apparatus 1 develops, cleans and dries the substrate W. In the specification, these processes are entirely called a “substrate developing method”. Particularly, cleaning and drying is called “substrate cleaning and drying method”.

The developing apparatus 1 includes a spin chuck 3. The spin chuck 3 holds the substrate W substantially horizontally. The spin chuck 3 suction-holds a lower surface of the substrate W. The spin chuck 3 is connected to a motor 7 via a rotary shaft 5. The motor 7 rotates the rotary shaft 5. Consequently, the substrate W is rotated around a substantially vertical axis VA, the axis passing through the center of the substrate W.

A scatter preventive cup 11 is arranged around the spin chuck 3. The scatter preventive cup 11 collects the developer scattering from the substrate W and guides the developer downwardly. A lower portion of the scatter preventive cup 11 is connected to a drain tube 12 and an exhaust tube 13. The drain tube 12 drains the collected developer out of the scatter preventive cup 11. The exhaust tube 13 exhausts gas (containing mist or particles) in the scatter preventive cup 11 externally.

The apparatus 1 further includes a developer nozzle 15, a cleaning liquid nozzle 17, and a gas nozzle 19. Each of the nozzles 15, 17, 19 ejects the developer, the cleaning liquid, and gas, respectively. The cleaning liquid nozzle 17 is integrated with the gas nozzle 19. For instance, the cleaning liquid is deionized water. For instance, gas is nitrogen gas.

The developer nozzle 15 is in communication with a developer supplying source 22 via a developer pipe 21. A switch valve 23 is provided at some midpoint of the developer pipe 21. The developer nozzle 15 is supported with a developer nozzle moving mechanism 24. The developer nozzle moving mechanism 24 moves the developer nozzle 15 between a processing position and a standby position. The processing position is, for example, a position above the center of the substrate W. The standby position is, for example, away from the position above the substrate W. FIG. 1 illustrates by solid lines the developer nozzle in the standby position.

The cleaning liquid nozzle 17 is in communication with a cleaning liquid supplying source 26 via a cleaning liquid pipe 25. A switch valve 27 is provided at some midpoint of the cleaning liquid pipe 25.

The gas nozzle 19 is in communication with gas supplying sources 32a, 32b via gas supplying pipes 31a, 31b, respectively. The gas supplying sources 32a, 32b supply the same type of gas (e.g., nitrogen gas). A switch valve 33a is arranged at some midpoint of the gas supplying pipe 31a. A switch valve 33b is arranged at some midpoint of the gas supplying pipe 31b.

The cleaning liquid nozzle 17 and the gas nozzle 19 are supported with a gas nozzle moving mechanism (hereinafter, abbreviated to “moving mechanism” where appropriate) 34. The moving mechanism 34 moves the cleaning liquid nozzle 17 and the gas nozzle 19. The cleaning liquid nozzle 17 is moved integrally with the gas nozzle 19.

Specifically, the moving mechanism 34 moves the cleaning liquid nozzle 17 and the gas nozzle 19 between a processing position and a standby position. The processing position is, for example, is a position above the center of the substrate W. FIG. 1 illustrates by dotted lines the cleaning liquid nozzle 17 and the gas nozzle 19 in the processing position. The standby position is, for example, away from the position above the substrate W. FIG. 1 illustrates by solid lines the cleaning liquid nozzle 17 and the gas nozzle 19 in the standby position.

Moreover, the moving mechanism 34 moves the cleaning liquid nozzle 17 and the gas nozzle 19 in the processing position vertically. Consequently, the moving mechanism 34 controls a distance (separation distance) between the gas nozzle 19 and the substrate W.

FIGS. 2A and 2B are a side view and a plan view of the gas nozzle and the cleaning liquid nozzle. FIG. 3 illustrates an internal structure of the gas nozzle.

As illustrated in FIGS. 2A and 2B, the gas nozzle 19 has a substantially cylindrical outer shape. The gas nozzle 19 is held with the central axis CA thereof substantially vertical. The gas nozzle 19 is smaller than the substrate W in plan view.

As illustrated in FIG. 3, the gas nozzle 19 includes a lower outlet 19a. The lower outlet 19a is in communication with the gas supplying pipe 31a.

As illustrated in FIG. 2A, the gas nozzle 19 has a side outlet 19b. The side outlet 19b is in communication with the gas supplying pipe 31b.

Reference is now made to FIG. 3. The lower outlet 19a is formed on a lower surface of the gas nozzle 19. The lower outlet 19a is circular. The lower outlet 19a has a diameter of several ten millimeters. The lower outlet 19a is relatively large. The lower outlet 19a ejects gas downwardly and substantially vertically. Each drawing schematically illustrates gas flow ejected from the lower outlet 19a by solid lines.

An internal space SI is formed above the lower outlet 19a. The cleaning liquid nozzle 17 is arranged in the internal space SI. The cleaning liquid nozzle 17 is of a straight-tube type (so-called a straight nozzle). A tip end (lower end) of the cleaning liquid nozzle 17 has a level higher than the lower outlet 19a. An outlet 17a is formed on the tip end of the cleaning liquid nozzle 17. The outlet 17a ejects the cleaning liquid.

Reference is made to FIG. 2A. The side outlet 19b is formed on a side face (a side outer circumference) of the gas nozzle 19. The side outlet 19b is a slit extending circumferentially. The side outlet 19b has a width smaller than the diameter of the lower outlet 19a. Here, the width of the side outlet 19b corresponds to a length of the side outlet 19b along the central axis CA. For instance, the width of the side outlet 19b is 4 mm. The side outlet 19b extends continuously on the entire periphery of the outer circumference. In other words, the side outlet 19b is annular. The side outlet 19b is arranged at a position slightly higher than the lower end face of the gas nozzle 19.

Each drawing schematically illustrates gas flow ejected from the side outlet 19b by dotted lines. As illustrated, the side outlet 19b ejects gas in a substantially horizontal direction. The substantially horizontal direction includes a horizontal direction and an obliquely downward direction. FIG. 2A illustrates the side outlet 19b ejecting gas in an obliquely downward direction. For instance, the obliquely downward direction is a direction inclined downwardly by approximately 5 degrees relative to the horizontal direction. Moreover, as illustrated in FIG. 2B, the side outlet 19b ejects gas over the periphery surrounding the side outer circumference of the gas nozzle 19 in plan view (over 360 degrees in every direction).

The gas nozzle 19 ejects gas in the processing position. Here, airflow ejected from the lower outlet 19a is called “inward airflow” where appropriate. Airflow ejected from the side outlet 19b is called “outward airflow” where appropriate. A positional relationship between the inward and outward airflow and substrate W is as under.

The outward airflow runs above the substrate W in a substantially horizontal direction, thereby covering a portion above the substrate W. The outward airflow runs from the center to the periphery edge of the substrate W in plan view. Here, a direction of the outward airflow substantially conforms to an outward radial direction of the substrate W.

The inward airflow runs between the outward airflow and the substrate W. Specifically, the inward airflow runs toward the center of the top face of the substrate W to impinge on the center. The inward airflow impinges on the center of the substrate W, and thereafter spreads circumferentially to reach the entire periphery edge of the substrate W.

Moreover, the apparatus 1 further includes a controller 37 configured to operate each component mentioned above. Specifically, the controller 37 drives the motor 7 to control spinning of the substrate W. The controller 37 drives the moving mechanisms 24, 34 to control each position of the nozzles 15, 17, 19. The controller 37 controls the switch valves 23, 27, 33a, 33b so as to open and close to switch supply and stop supply of the developer, the cleaning liquid and gas, respectively.

The controller 37 stores in advance process recipes (process program) about processing the substrate W. The controller 37 allows receipt of external commands about processing the substrate W. Then the controller 37 controls en bloc each component in accordance with the process recipes and the commands. The controller 37 is formed by a central processing unit (CPU) executing various processes, a RAM (Random-Access Memory) in the form of workspace of computations, and a storage medium such as a fixed disk storing a variety of information.

2. Operation

Description will be given next of operation of the developing apparatus 1 according to Embodiment 1.

FIG. 4 is a flow chart illustrating a procedure of a substrate developing method. FIG. 5 is a timing chart illustrating the procedure of the substrate developing method. FIGS. 6A to 6H are schematic views each illustrating a process to the substrate. FIG. 5 illustrates on the upper part thereof a variation with time of a spinning rate of the substrate. FIG. 5 illustrates on the lower part thereof a period of supplying the developer, the cleaning liquid, and gas.

As illustrated in FIGS. 4 and 5, the substrate developing method includes five steps. When one step is completed, the method proceeds to a next step. In this embodiment, a next step starts simultaneously with completion of the previous step.

It is assumed in the following description that the substrate W is already held by the spin chuck 3 with the surface thereof directed upward. As illustrated in FIG. 6A, an exposed resist film R adheres on the surface of the substrate W. The controller 37 basically controls operation of each component.

<Step S1> Developing Step

The developer nozzle moving mechanism 24 moves the developer nozzle 15 to the processing position. The motor 7 spins the substrate W. The switch valve 23 opens to cause the developer nozzle 15 to eject developer D to the substrate W. The developer D supplied to the substrate W spreads on the entire surface of the substrate W (see FIG. 6B). After a given period elapses, a spinning rate of the substrate W is decreased to a given spinning rate (e.g., 0 rpm or several tens rpm), whereby a puddle of the developer D is formed on the substrate W. The switch valve 23 closes to cause the developer nozzle 15 to stop ejection of the developer D. Then the developer nozzle 15 is moved to the standby position. The puddle of the developer D is maintained on the substrate W until a given period elapses. The developer D dissolves a dissoluble portion of the resist film R. Dissolving causes generation of a dissolved product.

<Step S2> Cleaning Step

The nozzles 17, 19 are moved from the standby position to the processing position. The spinning rate of the substrate W is increased to 1000 rpm, for example. The switch valve 27 opens to cause the cleaning liquid nozzle 17 to eject a cleaning liquid C to the substrate W. The cleaning liquid C supplied to the substrate W cleans off the developer D or the dissolved product on the substrate W. Accordingly, the developer D or the dissolved product is removed from the substrate W. The dissoluble portion of the resist film R is also removed from the substrate W, whereby resist patterns P1 to P4 appear on the substrate W (see FIG. 6C).

<Step S3> Puddle-Forming Step

The spinning rate of the substrate W is decreased to form a puddle of the cleaning liquid C on the substrate W. In this step, a spinning rate of the substrate W is, for example, 0 rpm or several tens rpm. The switch valve 27 closes to cause the cleaning liquid nozzle 17 to stop supplying the cleaning liquid C. The cleaning liquid C on the substrate W is not a plurality of separated lumps (liquid particles), but a single lump (liquid film). The liquid film covers the entire top face of the substrate W. Hereinafter, the liquid film of the cleaning liquid C is referred to as a “liquid film C” where appropriate. The liquid film C has a thickness (height) of approximately 2 mm to 3 mm, for example. The thickness is sufficiently larger than each height of the resist patterns P1 to P4. Each of the resist patterns P1 to P4 is entirely immersed in the cleaning liquid C.

<Step S4> Film-Thinning Step

The spinning rate of the substrate W is slightly increased. In this step, the spinning rate of the substrate W is, for example, approximately 400 rpm, and a spinning time is, for example, less than three seconds. Consequently, the cleaning liquid C on the substrate W is partially removed while the liquid film C is formed on the substrate W. This allows thinning of the liquid film C. In the film-thinning step, the thickness of the liquid film C is reduced by approximately half. For instance, the thickness is reduced to approximately 1 mm. Even after the film-thinning step, the liquid film C has a thickness sufficiently larger than each height of the resist patterns P1 to P4. Consequently, the resist patterns P1 to P4 are still immersed in the cleaning liquid C entirely (see FIG. 6E).

<Step S5> Drying Step

The gas nozzle 19 is moved downward to approach the substrate W. Consequently, a separation distance between the gas nozzle 19 and the substrate W is, for example, approximately 4 mm. Then the spinning rate of the substrate W is further increased. The switch valves 33a, 33b open to cause the gas nozzle 19 to eject gas from the lower outlet 19a and the side outlet 19b simultaneously.

The side outlet 19b ejects gas from a portion above the center of the substrate W in a substantially horizontal direction to generate the outward airflow. The outward airflow covers a portion above the substrate W. The lower outlet 19a ejects gas from the portion above the center of the substrate W downwardly in a substantially vertical direction to generate the inward airflow. The inward airflow impinges on the center of the substrate W substantially vertically.

The cleaning liquid C on the center of the substrate W starts to be moved circumferentially under a force due to impingement of the inward airflow and a centrifugal force due to spin of the substrate W. Then the resist patterns P2, P3 at the center of the substrate W are partially exposed (see FIG. 6F).

When the resist patterns P2, P3 are partially exposed from the cleaning liquid C, a force of collapsing the resist patterns P2, P3 occurs. The force is caused by surface tension of the cleaning liquid C. The force is also called “stress”. In the following description, the force is called a “collapse force” for convenience. In FIG. 6F, a collapse force occurs only in the resist patterns P2, P3, and no collapse force occurs in the resist patterns P1, P4.

Eventually, as illustrated in FIG. 6G, the cleaning liquid C is removed from the center of the substrate W, and the center is to be a dried portion. When the resist patterns P2, P3 are entirely exposed, a collapse force acting on the resist patterns P2, P3 is eliminated.

The inward airflow impinges on the center of the substrate W, and thereafter spreads circumferentially. The outward airflow runs over the inward airflow in a substantially horizontal direction, the inward airflow spreading circumferentially. The outward airflow guides the inward airflow such that the inward airflow spreading circumferentially has a lower level. For instance, the outward airflow acts so as to press the inward airflow spreading circumferentially against the top face of the substrate W. Consequently, the inward airflow runs along and close to the surface of the substrate W to reach the periphery edge of the substrate W. The inward airflow spreading circumferentially causes further movement of the cleaning liquid C to the periphery edge of the substrate W. The centrifugal force due to spinning of the substrate W compensates a force of the inward airflow to facilitate movement of the cleaning liquid C.

The dried portion expands from the center of the substrate W in concentric circles along with movement of the cleaning liquid C. Then the cleaning liquid C moved to the periphery edge of the substrate W is disposed of outside the substrate W. This allows removal of the cleaning liquid C from the substrate W, and thus the substrate W is entirely dried (see FIGS. 6F to 6H).

It is preferable that a certain clearance is formed between the outward airflow and the periphery edge of the substrate W. This allows the inward airflow to reach the periphery edge of the substrate W smoothly with no interference between the inward airflow and the outward airflow.

The inward airflow and the outward airflow reaching the periphery edge is sucked by the exhaust tube 13, thereby each being deflected downward. Then the inward airflow and the outward airflow runs toward the below of the substrate W.

It is preferable that the spinning rate of the substrate W in the drying step has a given upper limit or less, and the periphery edge of the substrate W is not dried prior to the inside of the periphery edge.

Reference is made to FIG. 7. FIG. 7 is an explanatory view of a primary drying. As illustrated, although the cleaning liquid C still remains on the substrate W, the periphery edge of the substrate W is primarily dried. Such primary drying occurs with an extremely high spinning rate of the substrate W. When the primary drying occurs, the cleaning liquid C cannot be moved smoothly to the periphery edge. As a result, a water mark may be generated, resulting in decreased quality of substrate processing.

The upper limit mentioned above is preferably set to be smaller as a size of the substrate W becomes larger. For instance, the size of the substrate W corresponds to the diameter of the substrate W. Consequently, the primary drying can be avoided suitably. Moreover, reduced quality of substrate processing can suitably be eliminated. When the substrate W is a circular substrate having a diameter of 300 mm, the spinning rate of the substrate W is preferably 2000 rpm or less, for example.

3. Effect

As noted above, in the drying step according to Embodiment 1, the cleaning liquid C is moved with a force of the inward airflow and the centrifugal force. In addition, the outward airflow covering the substrate W is generated. The inward airflow runs between the outward airflow and the substrate W. This allows the inward airflow to move the cleaning liquid C effectively. Consequently, the cleaning liquid C can be removed rapidly from the substrate W, achieving drying the substrate W in a short time.

The outward airflow runs in a substantially horizontal direction. This allows the outward airflow to cover the substrate W held in the substantially horizontal direction suitably.

The inward airflow runs to the top face of the substrate W to impinge on the cleaning liquid C on the substrate W. This allows the inward airflow to move the cleaning liquid C actively. Moreover, since the inward airflow impinges on the center of the substrate W, the center of the substrate W can be dried primarily. In addition, since the inward airflow impinges on the center of the substrate W vertically, the cleaning liquid C can be moved uniformly from the center to the entire periphery edge of the substrate W.

After impinging on the substrate W, the inward airflow spreads over uniformly (in concentric circles). The outward airflow guides the inward airflow spreading circumferentially such that the inward airflow runs close to the top face of the substrate W. The inward airflow spreading circumferentially runs close to the cleaning liquid C on the substrate W or runs contacting the cleaning liquid C on the substrate W. Consequently, the inward airflow spreading circumferentially allows the cleaning liquid C to be moved to the periphery edge of the substrate.

In addition, the outward airflow also runs from the center to the periphery edge of the substrate W in plan view. The direction of the outward airflow is the same as that of the inward airflow spreading circumferentially. Accordingly, the outward airflow can guide the inward airflow smoothly. Consequently, the cleaning liquid C can be moved more suitably to the periphery edge.

From these results, the dried portion expands from the center of the substrate W entirely and uniformly. Consequently, the substrate W can be dried entirely and uniformly.

The outward airflow blocks off mist or particles. Consequently, mist or particles airborne above the outward airflow can be prevented from adhering on the substrate W.

The outward airflow mentioned above is generated by ejecting gas from a portion above the center of the substrate W in a substantially horizontal direction. In this way, ejecting gas from a suitable position in a suitable direction allows suitable generation of the outward airflow. Similarly, the inward airflow is generated by ejecting gas downwardly from a portion above the center of the substrate W in the substantially vertical direction. In this way, ejecting gas from a suitable position in a suitable direction allows suitable generation of the inward airflow. Here, the position and direction of ejecting gas are set individually in accordance with types of airflow. This achieves suitable generation of both the outward airflow and the inward airflow.

Moreover, the single gas nozzle 19 is provided that allows simultaneous generation of the outward airflow and the inward airflow as noted above. This achieves a reduced number of parts. The gas nozzle 19 includes the lower outlet 19a and the side outlet 19b, allowing suitable generation of two types of airflow.

Moreover, in the drying step, not the cleaning liquid C or the developer D but only gas is ejected, as illustrated in the lower part of FIG. 5. Consequently, comparing to ejection of gas simultaneously with the cleaning liquid C and the developer D, a discharge amount of gas (each flow rate of the airflow) can be increased easily. This allows a shorten time for the drying step.

Moreover, the puddle-forming step ensures to immerse each of the resist patterns P1 to P4 in the cleaning liquid C even when the resist film R has repellency. Consequently, the resist patterns P1 to P4 can be protected from the collapse force until just before the drying step. In addition, in the drying step, the substrate W can be dried in a short time as mentioned above. This shortens a period when the collapse force occurs. Consequently, collapse of the resist patterns P1 to P4 can suitably be suppressed.

Moreover, the film-thinning step allows a reduced amount of the cleaning liquid (liquid film) C on the substrate W with no occurrence of the collapse force. This achieves a further shortened time for the drying step.

Moreover, in the film-thinning step, no gas is supplied from the gas nozzle 19. That is, only the centrifugal force causes partial removal the cleaning liquid C on the substrate W. Consequently, splashes of the cleaning liquid C can be reduced.

### Embodiment 2

Description will be given next of Embodiment 2 with reference to drawings.

FIG. 8 is a block diagram schematically illustrating a developing apparatus according to Embodiment 2. Like reference signs are used to identify like components which are the same as in the Embodiment 1 and will not particularly be described.

A cleaning liquid nozzle 17 ejects two types of cleaning liquids selectively. One cleaning liquid has surface tension different from that of the other cleaning liquid. Hereinafter, one cleaning liquid having relatively high surface tension is called a “cleaning liquid Ca”, and the other cleaning liquid a “cleaning liquid Cb”. The cleaning liquid Ca is, for example, deionized water. The cleaning liquid Cb is, for example, a mixed solution of deionized water and a surfactant (referred to as a “surfactant solution”). The cleaning liquids Ca, Cb, when not distinguished from one another, will be referred to simply as a “cleaning liquid C”.

The cleaning liquid pipe 25 is branched to two branch pipes 25a, 25b. The branch pipes 25a, 25b are in communication with cleaning liquid supplying sources 26a, 26b, respectively. The cleaning liquid supplying source 26a supplies a cleaning liquid Ca. The cleaning liquid supplying source 26b supplies a cleaning liquid Cb. Switch valves 27a, 27b are arranged at some midpoints of the branch pipe 25a, 25b, respectively.

2. Operation

Description will be given next of operation of the developing apparatus 1 according to Embodiment 2.

FIG. 9 is a flow chart illustrating a procedure of processes by the developing apparatus 1. It is assumed in the following description that the substrate W is already held by the spin chuck 3 with the surface of the substrate W directed upward. An exposed resist film R adheres on the surface of the substrate W. The controller 37 basically controls operation of each component.

<Step S11> Developing Step

Developer is supplied to the substrate W to develop the substrate W.

<Step S12> Cleaning Step

The cleaning liquid Ca is supplied to the developed substrate W to clean the substrate W. Then the developer is removed from the substrate W.

<Step S13> Replacing Step

The cleaning liquid Cb is supplied to the substrate W to replace the cleaning liquid Ca on the substrate W by the cleaning liquid Cb. Then the cleaning liquid Ca is removed from the substrate W.

<Step S14> Puddle-Forming Step

A spinning rate of the substrate W is decreased. This causes puddle formation of the cleaning liquid Cb on the substrate W.

<Step S15> Film-Thinning Step

The thickness of the cleaning liquid Cb applied to the substrate W is reduced.

<Step S16> Drying Step

The substrate W is spun and outward airflow and inward airflow is generated. In addition, in Embodiment 2, a gas nozzle 19 is moved from a portion above the center of the substrate W.

Reference is made to FIGS. 10A to 10D. FIGS. 10A to 10D are schematic view each illustrating process in the drying step.

In the early stages of the drying step, the gas nozzle 19 is located above the center of the substrate W. The inward airflow impinges on the center of the substrate W (see FIG. 10A). This makes the center of the substrate W a primary dried portion (see FIG. 10B).

Subsequently, the gas nozzle 19 is moved while ejecting gas from the processing position in the substantially horizontal direction (e.g., a radial direction of the substrate W). The inward airflow impinges on an area out of the center of the substrate, and moves the cleaning liquid Cb on the area actively (see FIG. 10C). Accordingly, drying the area out of the center can be further facilitated. Here, the outward airflow still covers the portion above of the substrate W after the gas nozzle 19 is moved. This allows drying the entire substrate W in a shorter time (see FIG. 10D). Here, the positions of the gas nozzle 17 illustrated in FIGS. 10A, 10B and the positions of the gas nozzle 17 illustrated in FIG. 10C, 10D each correspond to the processing position.

3. Effect

As noted above, Embodiment 2 can produce a similar effect as that of Embodiment 1 that the substrate W can be dried in a short time.

Moreover, in the drying step, moving the gas nozzle 19 allows more rapid drying of the area out of the center of the substrate W. As a result, the substrate W can be dried entirely in a shorter time.

In addition, the replacing step allows replacement of a cleaning liquid used in the cleaning step by a cleaning liquid used in the puddle-forming step and later steps. Consequently, the cleaning liquid Ca suitable for use in the cleaning step can be used in the cleaning step. For instance, deionized water is used as the cleaning liquid Ca in the cleaning step. This enhances cleaning quality. Similarly, in the puddle-forming step and later steps, the cleaning liquid Cb suitable for use in the puddle-forming step may be used. For instance, in the puddle-forming step and later steps, a surfactant solution is used as the cleaning liquid Cb. Consequently, a collapse force itself can be reduced. Moreover, the cleaning liquid Cb can be moved with a smaller force. This allows the cleaning liquid Cb to be removed from the substrate W more rapidly, achieving drying the substrate W in a shorter time. Consequently, collapse of the resist patterns P1 to P4 can be further suppressed.

This invention is not limited to the foregoing examples, but may be modified as follows.

(1) In Embodiments 1 and 2 mentioned above, a puddle of the developer is formed on the substrate W in the developing step. This is not limitative. The developing step may be modified into various modes. For instance, the developer may be ejected continuously until completion of the developing step. Alternatively, the developer nozzle 15 may be changed to a slit nozzle having a length substantially equal to the diameter of the substrate W.

(2) In Embodiments 1 and 2 mentioned above, the single gas nozzle 19 generates the outward airflow and the inward airflow. This is not limitative. For instance, an outward airflow nozzle exclusively generating outward airflow and an inward airflow nozzle exclusively generating inward airflow may be provided individually.

(3) In Embodiment 1 mentioned above, one type of a cleaning liquid is used, whereas in Embodiment 2 two types of cleaning liquids are used. This is not limitative. For instance, three types of cleaning liquids may be used.

(4) Embodiments 1, 2 mentioned above, and Modifications mentioned in the above (1) to (3) may be modified as appropriate by replacing or combining each of the constructions above by or with another construction.

The present invention may be embodied in other specific forms without departing from the spirit or essential attributes thereof and, accordingly, reference should be made to the appended claims, rather than to the foregoing specification, as indicating the scope of the invention.

What is claimed is:

1. A substrate cleaning and drying method comprising:
a cleaning step of cleaning a developed substrate by supplying a cleaning liquid to the substrate;
a puddle-forming step of forming a puddle of the cleaning liquid on the substrate;
a film-thinning step of thinning a film thickness of the cleaning liquid on the substrate; and
a drying step of drying the substrate by spinning the substrate and generating outward airflow and inward airflow between the outward airflow and the substrate, the outward airflow covering a portion above the substrate and the inward airflow causing removal of the cleaning liquid on the substrate.

2. The substrate cleaning and drying method according to claim 1, wherein
the inward airflow runs to a top face of the substrate, and
the outward airflow runs in the portion above the substrate in a substantially horizontal direction.

3. The substrate cleaning and drying method according to claim 2, wherein
the inward airflow impinges on the top face of the substrate to spread circumferentially, and
the outward airflow causes a reduced level of the inward airflow spreading circumferentially.

4. The substrate cleaning and drying method according to claim 1, wherein
the outward airflow runs from the center toward a periphery edge of the substrate in plan view, and
the inward airflow impinges on the center of the substrate to spread to the periphery edge of the substrate.

5. The substrate cleaning and drying method according to claim 4, wherein
the outward airflow is generated by ejecting gas from a portion above the center of the substrate in a substantially horizontal direction, and
the inward airflow is generated by ejecting gas downwardly from the portion above the center of the substrate in a substantially vertical direction.

6. The substrate cleaning and drying method according to claim 1, wherein
the outward airflow and the inward airflow is generated simultaneously through a single gas nozzle.

7. The substrate cleaning and drying method according to claim 6, wherein
the outward airflow is generated by ejecting gas circumferentially from a side face of the gas nozzle, and
the inward airflow is generated by ejecting gas downwardly from a lower surface of the gas nozzle.

8. The substrate cleaning and drying method according to claim 6, wherein
the gas nozzle is smaller than the substrate in plan view.

9. The substrate cleaning and drying method according to claim 1, wherein
in the drying step, the gas nozzle is moved from the portion above the center of the substrate in a substantially horizontal direction while generating the outward airflow and the inward airflow.

10. The substrate cleaning and drying method according to claim 1, wherein
no cleaning liquid is supplied to the substrate in the drying step.

11. The substrate cleaning and drying method according to claim 1, wherein
a periphery edge of the substrate is not dried prior to an inside of the periphery edge in the drying step with a spinning rate of the substrate being a given upper limit or less.

12. A substrate developing method comprising:
a developing step of developing a substrate by supplying developer to the substrate:
a cleaning step of cleaning the substrate by supplying a cleaning liquid to the developed substrate;
a puddle-forming step of forming a puddle of the cleaning liquid on the substrate;
a film-thinning step of thinning a film thickness of the cleaning liquid on the substrate; and
a drying step of drying the substrate by spinning the substrate and generating outward airflow and inward airflow between the outward airflow and the substrate, the outward airflow covering a portion above the substrate and the inward airflow causing movement of the cleaning liquid on the substrate.
